(19) United States
(12) Patent Application Publication
(10) Pub. No.: US 2026/0029682 A1
(43) Pub. Date: Jan. 29, 2026

(54) OPTICAL MODULATOR, VISIBLE LIGHT SOURCE MODULE, OPTICAL ENGINE, IMAGE DISPLAY DEVICE, XR GLASSES, AND METHOD FOR CONTROLLING OPTICAL MODULATOR

(71) Applicant: TDK CORPORATION, Tokyo (JP)

(72) Inventors: Shigeru MIEDA, Tokyo (JP); Yasuhiro TAKAGI, Tokyo (JP); Jiro YOSHINARI, Tokyo (JP)

(73) Assignee: TDK CORPORATION, Tokyo (JP)

(21) Appl. No.: 19/275,411

(22) Filed: Jul. 21, 2025

(30) Foreign Application Priority Data
Jul. 25, 2024 (JP) 2024-119572

(51) Int. Cl. G02F 1/21; G02B 27/01; G02F 1/225

(52) U.S. Cl. CPC G02F 1/212; G02B 27/0172; G02F 1/225; G02B 2027/0178

(57) ABSTRACT

The optical modulator of the present disclosure includes: Mach-Zehnder optical modulation units with optical waveguide and an electrode; a power supply for applying a pixel voltage to Mach-Zehnder optical modulation units independently; and a control unit controlling the power supply, wherein the control unit controls the power supply to apply the pixel voltage with a predetermined applied voltage width, the control unit is configured to repeat a set of a step 1 and a step 2, in the step 1, application of the pixel voltage having one polarity to Mach-Zehnder optical modulation units being continued during a predetermined pixel voltage application continuation period, and in the step 2, a shift voltage that is an even multiple of a half-wavelength voltage being applied to Mach-Zehnder optical modulation units and application of the pixel voltage having other polarity being continued during the pixel voltage application continuation period after the step 1.

### CROSS-REFERENCES TO RELATED APPLICATIONS

This application relies for priority upon Japanese Patent Application No. 2024-119572 filed on Jul. 25, 2024, the entire content of which is hereby incorporated herein by reference for all purposes as if fully set forth herein.

### BACKGROUND

The present disclosure relates to an optical modulator, a visible light source module, an optical engine, an image display device, XR glasses, and a method for controlling an optical modulator.

XR glasses such as AR (Augmented Reality) glasses and VR (Virtual Reality) glasses are expected to be small wearable devices. The key to the widespread use of XR glasses is to miniaturize them so that each function fits into the size of a normal pair of glasses. In this situation, Mach-Zehnder optical modulators using lithium niobate films are expected as a promising candidate (for example, see Patent Documents 1 and 2).

It is known that a phenomenon called DC drift occurs in Mach-Zehnder optical modulators using lithium niobate films, in which the bias voltage-optical output characteristic shifts over time in the bias voltage direction. Therefore, even if a constant bias voltage is applied to a Mach-Zehnder optical modulator, the optical output changes over time due to DC drift, making it difficult to obtain a constant optical output over the long term.

Patent Document 1 discloses an disclosure that follows changes in the operating point voltage caused by DC drift by performing feedback control on the bias voltage based on the average intensity of the output light. This disclosure is a means to solve the limitation of product life caused by the range in which the operating point voltage can be followed is limited by the withstand voltage of the modulator or IC. In addition, this disclosure is a means to control the DC drift while keeping the operating point voltage within a specified range by utilizing the property that the direction of the DC drift is correlated with the polarity of the applied voltage and changing the bias voltage to a voltage of the opposite polarity when the operating point voltage range is exceeded.

### PRIOR ART DOCUMENTS

### Patent Documents

Patent Document 1: U.S. Pat. No. 7,306,347
Patent Document 2: U.S. Pat. No. 7,400,661
Patent Document 3: U.S. Pat. No. 2,518,138

### SUMMARY

However, the disclosure disclosed in Patent Document 1 requires an operating point voltage detection means for detecting the operating point voltage, which is the voltage at half the maximum optical output. Also, it requires input of two reference voltages for calculating the operating point and comparison, which complicates control and implementation.

When a Mach-Zehnder optical modulator using a lithium niobate film is applied to XR glass, the color corresponding to the drive voltage cannot be stably output continuously due to the change over time of the optical output caused by DC drift, so it is necessary to suppress or compensate for the DC drift.

The present disclosure has been made in consideration of the above-mentioned problems, and aims to provide an optical modulator, a visible light source module, an optical engine, an image display device, XR glasses, and a control method for an optical modulator that are capable of suppressing or compensating for DC drift.

In order to solve the above problems, the present disclosure provides the following means.

A first aspect of the present disclosure is an optical modulator for an image display device that displays an image on an image display surface by scanning a combined light of a plurality of color laser beams pixel by pixel at a predetermined time step, the optical modulator including: a plurality of Mach-Zehnder optical modulation units, each of which has a Mach-Zehnder optical waveguide formed of a ridge formed in a ferroelectric thin film represented by the chemical formula ABX₃ and an electrode for applying an electric field to the Mach-Zehnder optical waveguide; a power supply for applying a pixel voltage to each of the plurality of Mach-Zehnder optical modulation units independently; and a control unit configured to control the power supply, wherein the control unit is configured to control the power supply so as to apply the pixel voltage with a predetermined applied voltage width to each of the plurality of Mach-Zehnder optical modulation units independently, the control unit further configured to repeat a set of a step 1 and a step 2, in the step 1, application of the pixel voltage having one polarity to each of the plurality of Mach-Zehnder optical modulation units being continued during a predetermined pixel voltage application continuation period, and in the step 2, a shift voltage that is an even multiple of a half-wavelength voltage being applied to each of the plurality of Mach-Zehnder optical modulation units and application of the pixel voltage having other polarity being continued during the pixel voltage application continuation period after performing the step 1 in the set.

A second aspect of the present disclosure is an optical modulator for an image display device that displays an image on an image display surface by scanning a combined light of a plurality of color laser beams pixel by pixel at a predetermined time step, the optical modulator including: a plurality of Mach-Zehnder optical modulation units, each of which has a Mach-Zehnder optical waveguide formed of a ridge formed in a ferroelectric thin film represented by the chemical formula ABX₃ and an electrode for applying an electric field to the Mach-Zehnder optical waveguide; a power supply for applying a pixel voltage to each of the plurality of Mach-Zehnder optical modulation units independently; and a control unit configured to control the power supply, wherein the control unit is configured to control the power supply so as to apply the pixel voltage with a predetermined applied voltage width to each of the plurality of Mach-Zehnder optical modulation units independently, the control unit further configured to repeat a set of a step 1 and a step 2, in the step 1, application of the pixel voltage having one polarity to each of the plurality of Mach-Zehnder optical modulation units being continued during a predetermined pixel voltage application continuation period, and in the step 2, a shift voltage being applied to each of the plurality of Mach-Zehnder optical modulation units so that the applied voltage width is symmetrical with respect to an extreme value of an optical output in each modulation curve of the plurality of Mach-Zehnder type optical modulation units and application of a pixel voltage including the pixel voltage having other polarity being continued during the pixel voltage application continuation period after performing the step 1 in the set.

A third aspect of the present disclosure is the optical modulator of the first or second aspect, wherein the Mach-Zehnder optical waveguide is made of C-axis oriented lithium niobate.

A fourth aspect of the present disclosure is the optical modulator according to any one of the first to third aspects, wherein the Mach-Zehnder optical waveguide is made of X-cut lithium niobate.

A fifth aspect of the present disclosure relates to the optical modulator of any one of the first to fourth aspects, wherein the pixel voltage application continuation period is a time required to draw one or more rows of pixels in a raster scan.

A sixth aspect of the present disclosure relates to the optical modulator of any one of the first to fourth aspects, wherein the pixel voltage application continuation period is a time required to draw one or more frame images of a raster scan.

A seventh aspect of the present disclosure is a visible light source module including any one of the optical modulators of the first to sixth aspects and a plurality of visible light laser light sources each emitting a plurality of colored laser beams.

An eighth aspect of the present disclosure is an optical engine including the visible light source module of the seventh aspect, and a light scanning mirror configure to reflect the light emitted from the visible light source module at a different angle so as to display an image.

A ninth aspect of the present disclosure is an image display device including the optical engine according to the ninth aspect.

A tenth aspect of the present disclosure is the image display device according to the nine aspect, wherein the image device is an XR glass.

An eleventh aspect of the present disclosure is a method for controlling an optical modulator for an image display device that displays an image on an image display surface by scanning a combined light of a plurality of colored laser beams pixel by pixel at a predetermined time step, the method including the steps of: using an optical modulator including a plurality of Mach-Zehnder optical modulation units, a power supply for applying a pixel voltage to each of the plurality of Mach-Zehnder optical modulation units independently, and a control unit configured to control the power supply; and by the controlling unit, controlling the power supply so as to apply the pixel voltage with a predetermined applied voltage width to each of the plurality of Mach-Zehnder optical modulation units independently, and further controlling such that a set of a step 1 and a step 2 is repeated, in the step 1, application of the pixel voltage having one polarity to each of the plurality of Mach-Zehnder optical modulation units being continued during a predetermined pixel voltage application continuation period, and in the step 2, a shift voltage that is an even multiple of a half-wavelength voltage being applied to each of the plurality of Mach-Zehnder optical modulation units and application of the pixel voltage having other polarity being continued during the pixel voltage application continuation period after performing the step 1 in the set.

A twelfth aspect of the present disclosure is a method for controlling an optical modulator for an image display device that displays an image on an image display surface by scanning a combined light of a plurality of colored laser beams pixel by pixel at a predetermined time step, the method including the steps of: using an optical modulator including a plurality of Mach-Zehnder optical modulation units, a power supply for applying a pixel voltage to each of the plurality of Mach-Zehnder optical modulation units independently, and a control unit configured to control the power supply; and by the controlling unit, controlling the power supply so as to apply the pixel voltage with a predetermined applied voltage width to each of the plurality of Mach-Zehnder optical modulation units independently, and further controlling such that a set of a step 1 and a step 2 is repeated, in the step 1, application of the pixel voltage having one polarity to each of the plurality of Mach-Zehnder optical modulation units being continued during a predetermined pixel voltage application continuation period, and in the step 2, a shift voltage being applied to each of the plurality of Mach-Zehnder optical modulation units so that the applied voltage width is symmetrical with respect to an extreme value of an optical output in each modulation curve of the plurality of Mach-Zehnder type optical modulation units and application of a pixel voltage including the pixel voltage having other polarity being continued during the pixel voltage application continuation period after performing the step 1 in the set.

According to the optical modulator of the present disclosure, it is possible to provide an optical modulator capable of suppressing or compensating for DC drift.

### BRIEF DESCRIPTION OF THE DRAWINGS

FIG. 1 is a conceptual diagram of a Mach-Zehnder optical modulator.

FIG. 2 is a diagram showing the basic configuration of an optical modulator.

FIG. 3 is a diagram for explaining a case where the modulation curve of an LN optical modulator shifts to the positive side due to DC drift caused by a positive bias voltage.

FIG. 4 is a schematic diagram of an image display device including a optical modulator according to the present disclosure.

FIG. 5A is a conceptual diagram showing a drawing area on an image display surface, illustrating an example of a scanning method.

FIG. 5B is a conceptual diagram showing a pattern of pixel voltages (pixel signals) applied to one of the RGB Mach-Zehnder type light-modulating units, with the horizontal axis representing time and the vertical axis representing a pixel voltage (pixel signal) applied to one of the RGB Mach-Zehnder type light-modulating units.

FIG. 6 conceptually illustrates an arrangement of three consecutive pixels among the pixels that make up an image.

FIG. 7 conceptually illustrates combinations of pixel voltages (pixel signals) for each of RGB in one column of 1280 pixels when the number of pixels is “1280×720.”

FIG. 8A is a conceptual diagram showing a drawing area on an image display surface, illustrating an example of a scanning method.

FIG. 8B is a conceptually illustrates control for shifting the range of applied voltage width Vpp of pixel voltages by applying a shift voltage in the scanning method illustrated in FIG. 8A.

FIG. 8C is a diagram showing the application pattern of pixel voltages over time in scanning [1] of the first column and scanning [2] of the second column shown in FIG. 8A.

FIG. 9A is a conceptual diagram showing a drawing area on an image display surface, illustrating an example of a scanning method.

FIG. 9B conceptually illustrates control for shifting the range of applied voltage width Vpp of pixel voltages by applying a shift voltage in the scanning method illustrated in FIG. 9A.

FIG. 9C is a diagram showing the application pattern of pixel voltages over time in scanning [1] of the first column and scanning [2] of the second column shown in FIG. 9A.

FIG. 10 is a flowchart showing an example of control executed by a control unit on a optical modulator during image formation.

FIG. 11A is a schematic plan view of an optical modulator according to the present disclosure having three Mach-Zehnder optical waveguides 11 as shown in FIG. 2. Figure

FIG. 11B is a schematic plan view of another example of an optical modulator according to the present disclosure, which is the optical modulator shown in FIG. 11A except that it has an optical multiplexer.

FIG. 12 is a schematic cross-sectional view of the optical modulator shown in FIGS. 11A and 11B taken along line AA′.

FIG. 13 is a schematic plan view of a light source module according to the present disclosure.

FIG. 14 is a schematic cross-sectional view of a part of the light source module shown in FIG. 13 cut along the XZ plane, depicting only a part near the joint.

FIG. 15 is a conceptual diagram for explaining an example of XR glasses of the present disclosure.

FIG. 16 is a conceptual diagram showing how an image is directly projected onto the retina by laser light emitted from a light source module in the XR glasses shown in FIG. 15.

### DETAILED DESCRIPTION

The present disclosure will be described in detail below with reference to the drawings as appropriate. The drawings used in the following description may show characteristic parts in an enlarged scale for the sake of convenience in order to make the characteristics easier to understand, and the dimensional ratios of each component may differ from the actual ones. The materials, dimensions, etc. exemplified in the following description are merely examples, and the present disclosure is not limited thereto. They may be modified as appropriate within the scope of the effects of the present disclosure.

### [Optical Modulator]

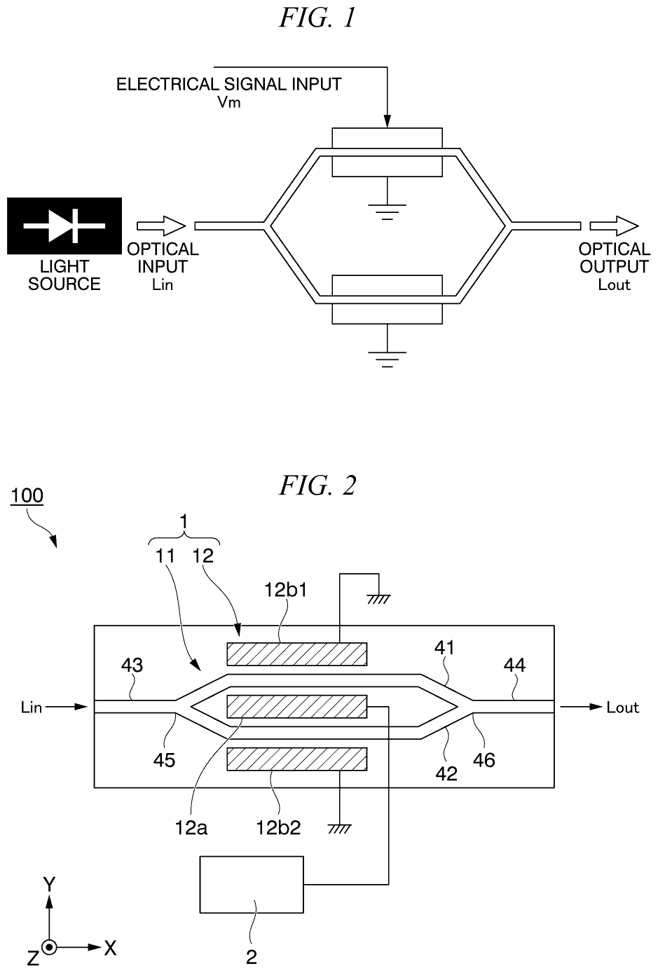

FIG. 1 shows a conceptual diagram of a Mach-Zehnder optical modulator.

The optical modulator according to the present disclosure is a Mach-Zehnder optical modulator (hereinafter, sometimes referred to as an “optical modulator” or an “LN optical modulator”) The optical modulator includes a Mach-Zehnder optical waveguide and an electrode for applying a modulation signal (drive signal) Vₘ.

In an operating LN optical modulator, in addition to the high-frequency signal VREF for modulation, a direct-current bias (DC bias) voltage V_{DC} for adjusting the modulation state of the optical output is applied to the electrodes. In this case, the bias voltage V_{DC} is the DC component of the modulation signal Vₘ.

The input light Lᵢₙ supplied from the light source is intensity-modulated by the LN optical modulator, and the intensity-modulated output light Lout is output.

FIG. 2 shows the basic configuration of an optical modulator.

The optical modulator 100 shown in FIG. 2 has a Mach-Zehnder optical modulation unit 1 having a Mach-Zehnder optical waveguide 11 and a modulation electrode (signal electrode) 12 for applying a modulation signal Vm to the Mach-Zehnder optical waveguide 11, and a control section 2 for supplying the modulation signal Vm to the modulation electrode 12. In FIG. 2, the X direction is a direction perpendicular to a side surface on which an input port through which input light is input is disposed, the Y direction is a direction perpendicular to the X direction, and the Z direction is a direction perpendicular to a plane formed by the X direction and the Y direction.

In the optical modulator according to the present disclosure, the control unit includes a high frequency signal pulse generation control circuit that controls application of a pixel voltage, and a DC bias control circuit, and may include an optical switch control circuit that controls on/off of an optical switch described below.

The Mach-Zehnder optical modulation unit 1 modulates the intensity of output light in response to a modulation signal Vm supplied to a modulation electrode 12. The Mach-Zehnder optical waveguide 11 branches one input waveguide (optical waveguide) 43 at a Y branch 45 into two ridge type optical waveguides, a first ridge type optical waveguide 41 and a second ridge type optical waveguide 42, and is again coupled to one output waveguide 44 at a Y branch 46. The modulation electrode 12 comprises a signal electrode 12a formed between the first ridge type optical waveguide 41 and the second ridge type optical waveguide 42, and counter electrodes 12b1 and 12b2 provided to sandwich the first ridge type optical waveguide 41 and the second ridge type optical waveguide 42.

In the optical modulator according to the present disclosure, the modulating electrode for the Mach-Zehnder optical waveguide can be arranged in a known manner. Although FIG. 2 shows an example in which the modulating electrode is arranged on the side of the Mach-Zehnder optical waveguide, a configuration in which the modulating electrode is arranged above the Mach-Zehnder optical waveguide may also be used.

In the configuration diagram shown in FIG. 2, only the modulation electrode 12 is provided for the high frequency signal V_{REF} and the DC bias voltage V_{DC}, but a configuration in which separate electrodes are provided for the high frequency signal V_{REF} and the DC bias voltage V_{DC} may be used.

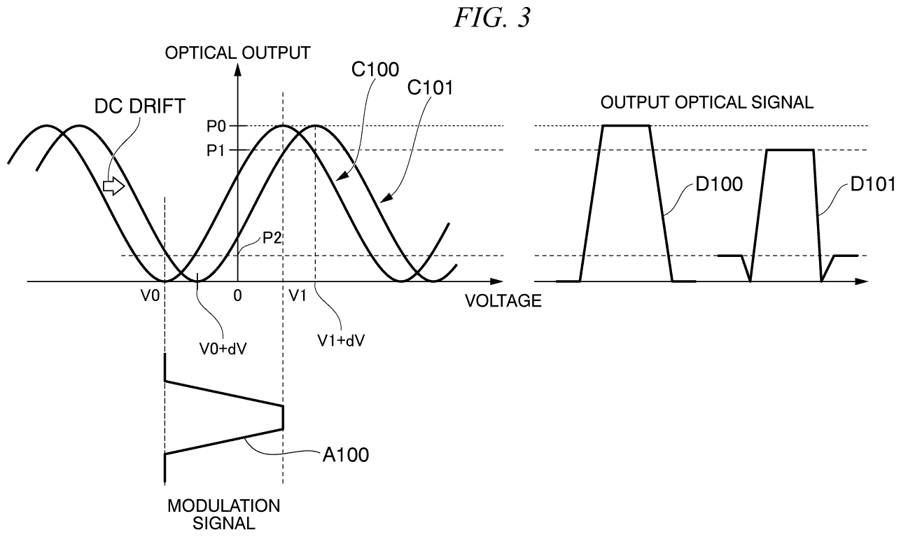

The Mach-Zehnder type optical modulation unit 1 has a modulation curve (operating characteristic curve; see FIG. 3) specific to the optical modulator, and the input light is modulated by the modulation signal Vm applied in accordance with this modulation curve, and output as an output optical signal.

It is known that when the modulation signal Vₘ contains a DC bias voltage V_{DC}, which is a direct current component, a phenomenon occurs in which the modulation curve (operating characteristic curve) moves over time (DC drift) depending on the polarity of the DC bias voltage V_{DC}.

FIG. 3 is a diagram for explaining a case where the modulation curve of the LN optical modulator shifts to the positive side due to DC drift caused by a positive bias voltage.

The modulation curve of an LN optical modulator is expressed as the optical output (optical intensity) of the output light periodically increasing and decreasing with increasing applied voltage.

In FIG. 3, the symbol C100 is the modulation curve when no DC drift occurs, and symbol C101 is the modulation curve when DC drift occurs. Symbol D100 is the output optical signal when no DC drift occurs, and symbol D101 is the output optical signal when DC drift occurs. A100 is the modulation signal (driving voltage).

The example shown in FIG. 3 is the case where the voltages at which the minimum value (0) and maximum value (P₀) of the optical output corresponding to the input signal as a binary signal are obtained are V₀ and V₁, respectively. If the voltages V₀ and V₁ are fixed when DC drift occurs, the optical output at voltages V₀ and V₁ will be P₂ and P₁, respectively, due to the periodicity of the modulation curve. If the amount of drift is dV, in order to maintain the optical output before the DC drift after the DC drift, it becomes necessary to compensate for the DC drift by setting the voltages V₀ and V₁ to (V₀+dV) and (V₁+dV), respectively.

Although FIG. 3 shows the DC drift due to a positive bias voltage, the DC drift due to a negative bias voltage moves to the negative side.

The optical modulator disclosed herein is an optical modulator for an image display device that displays an image on an image display surface (projection surface) by scanning a combined light of multiple color laser beams pixel by pixel at a predetermined time step, and includes multiple Mach-Zehnder optical modulation units. Each Mach-Zehnder optical modulation unit has a Mach-Zehnder optical waveguide made of a ridge formed in a ferroelectric thin film represented by the chemical formula ABX₃, and an electrode for applying an electric field to the Mach-Zehnder optical waveguide. As the ferroelectric thin film represented by the chemical formula ABX₃, oxide ferroelectrics such as barium titanate (BaTiO₃), lithium niobate (LiNbO₃), lithium tantalate (LiTaO₃), etc., can be used. In particular, lithium niobate (LiNbO₃) is preferable.

The optical modulator according to the present disclosure further includes a power supply for applying a pixel voltage independently to each of the multiple Mach-Zehnder optical modulation units, and a control section 2 for controlling the power supply, and the control section 2 can control the power supply so as to apply a pixel voltage with a predetermined applied voltage width independently to each of the multiple Mach-Zehnder optical modulation units (1-1, 1-2, 1-3). The control section 2 can further control the power supply to perform step 1 of continuing application of a pixel voltage of one polarity to each of the multiple Mach-Zehnder optical modulation units (1-1, 1-2, 1-3) for a predetermined pixel voltage application continuation period, and after performing step 1, perform step 2 of applying a shift voltage to each of the multiple Mach-Zehnder optical modulation units to continue application of a pixel voltage of the other polarity for the pixel voltage application continuation period, and repeat step 1 and step 2.

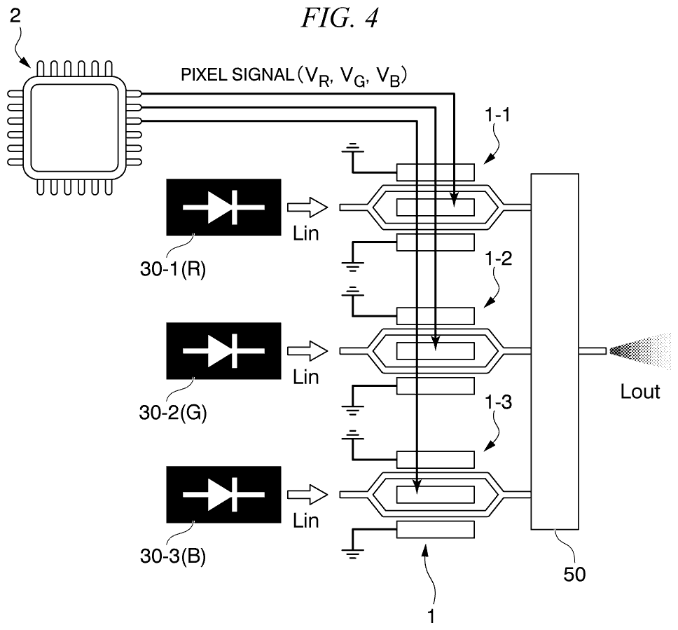

FIG. 4 is a schematic diagram of an image display device including a optical modulator according to the present disclosure.

The image display device shown in FIG. 4 is an image display device capable of full-color display, including red (R), green (G), and blue (B) visible light laser light sources 30-1, 30-2, and 30-3, which are arranged so that they can be incident on Mach-Zehnder optical modulation units 1-1, 1-2, and 1-3, respectively; however, the optical modulator according to the present disclosure can be applied to any image display device that includes two or more light sources that emit light of different colors.

Reference numeral 50 denotes an optical multiplexer.

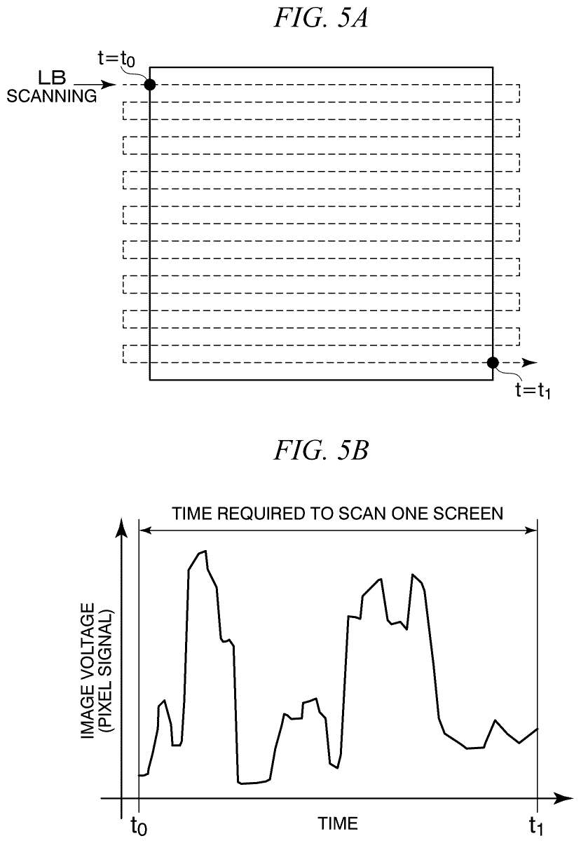

FIG. 5A shows a drawing area on an image display surface, and is a conceptual diagram showing an example of a scanning method in which an image is displayed by changing the light intensity (color tone) for each pixel while scanning a laser beam using an image display device equipped with an optical modulator according to the present disclosure. FIG. 5B is a conceptual diagram showing a pattern of pixel voltages (pixel signals) applied to one of the Mach-Zehnder optical modulators for RGB on the vertical axis, with time on the horizontal axis.

As shown in FIG. 5A, a laser beam (LB) is scanned in sequence to form an image. The start time of scanning to display an image is to, and the end time of scanning is t₁.

The arrow in FIG. 5A indicates the scanning direction of the laser light, and the laser light scans one pixel at a time from left to right, and when it reaches the right end, it goes down one row and scans one pixel at a time from right to left, and when it reaches the left end, it goes down one row and scans one pixel at a time from left to right, repeating this scanning (raster scan). This scanning method is one example, and any scanning method that scans one pixel at a time may be used.

As the laser beam moves through each dot (pixel) of the image, the color of the laser changes over time. It takes a certain amount of time to form one image, but the human eye cannot keep up with this speed, so it is recognized as one image. The scanning speed of the laser beam is generally around 100 to 500 MHz (a speed at which the entire image switches 60 times per second). For example, if the drawing time for one pixel is 10 ns (nanoseconds), this is much shorter than the time constant of DC drift (up to 200 ms (milliseconds)).

Color tones are changed by changing the light intensity of the three primary colors of light: red (R), green (G), and blue (B). For example, if the intensity of each color is changed using 8 bits of red, 8 bits of green, and 8 bits of blue, the combined color will have 24-bit color tones (approximately 16.77 million colors) (24-bit color method). In the 24-bit color method, each RGB color has 8 bits of information, and each can be reproduced in 256 gradations. Each RGB has a voltage value ranging from 0 to 255; for example, when all RGB are 0, the result is black, and when all are 255, the result is white.

FIG. 6 conceptually shows an arrangement of three consecutive pixels among the pixels that make up one image.

The color displayed by each pixel is determined by a combination of the light intensities of three colors: red (R), green (G), and blue (B).

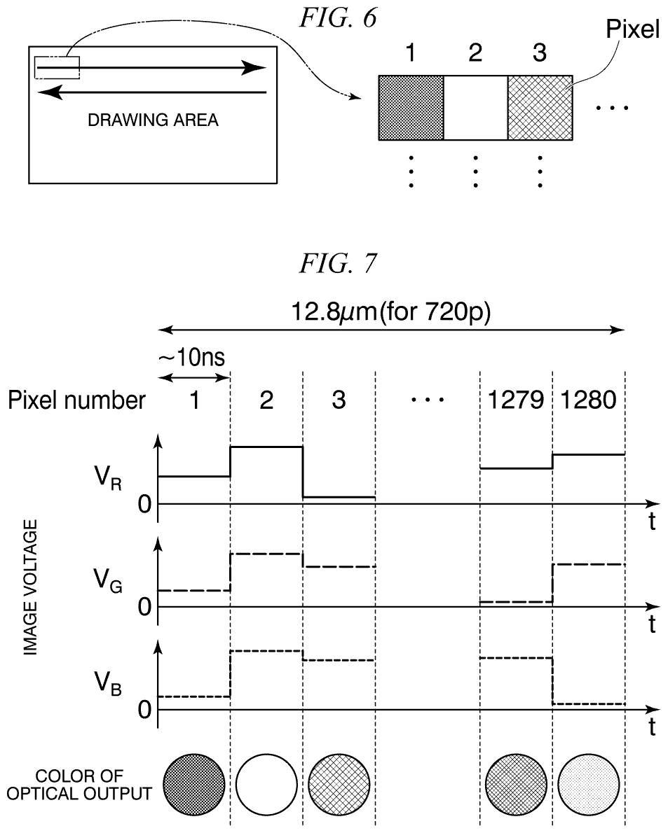

FIG. 7 conceptually illustrates combinations of pixel voltages (pixel signals) for each of RGB in each of 1280 pixels in one column when the number of pixels is “1280×720.”

The 1280 pixels are named, from left to right, as pixel number 1, pixel number 2, pixel number 3, . . . , pixel number 1279, and pixel number 1280.

When the drawing time for one pixel is 10 ns, the time required for scanning one row is 12.8 μs (microseconds), and the time required for displaying one screen is approximately 10 ms (milliseconds).

The optical modulator according to the present disclosure may include an integrating circuit that enables the control unit to obtain an integrated value of the pixel voltages applied to each of the multiple Mach-Zehnder optical modulation units during the pixel voltage application continuation period.

In the driving example shown in FIG. 7, when scanning one column, if the pixel voltages applied to the Mach-Zehnder type light modulation unit for red (R) for pixel number 1, pixel number 2, pixel number 3, . . . , pixel number 1279, and pixel number 1280 are V_{R}(1), V_{R}(2), V_{R}(3), . . . , V_{R}(1279), and V_{R}(1280), respectively, after the application time of these pixel voltages, a DC drift corresponding to the pixel voltage integrated value obtained by integrating each pixel voltage x one pixel drawing time can occur. Similarly, in the green (G) Mach-Zehnder optical modulation unit, a DC drift may occur according to an integrated pixel voltage value obtained by integrating each pixel voltage of V_{G}(1), V_{G}(2), V_{G}(3), . . . , V_{G}(1279), and V_{G}(1280) times one pixel drawing time, and in the blue (B) Mach-Zehnder optical modulation unit, a DC drift may occur according to an integrated pixel voltage value obtained by integrating “each pixel voltage of V_{B}(1), V_{B}(2), V_{B}(3), . . . , V_{B}(1279), and V_{B}(1280) times one pixel drawing time.”

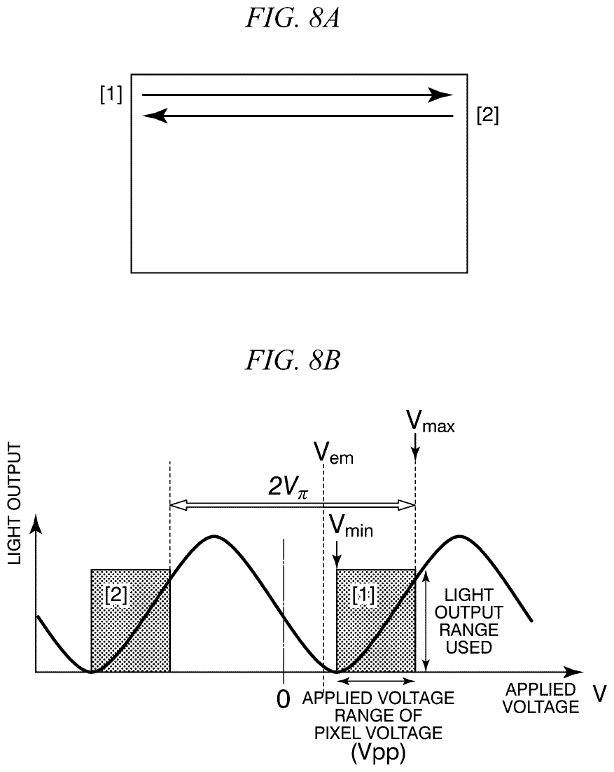

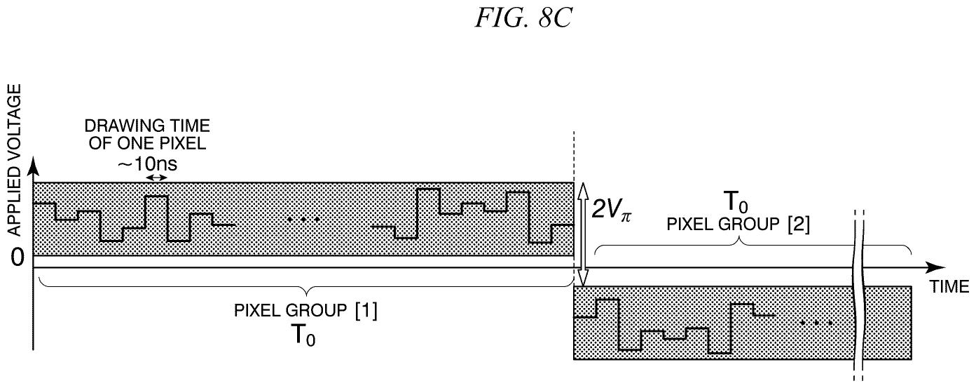

Using FIGS. 8A to 8C, an embodiment of a method for controlling the application of pixel voltages to a Mach-Zehnder optical modulation unit performed in the optical modulator of the present disclosure will be conceptually explained. The example shown in FIGS. 8A to 8C is a case where a shift voltage is applied for each row of raster scanning.

FIG. 8A shows a drawing area on an image display surface, and is a conceptual diagram showing an example of a scanning method.

In FIG. 8A, [1] indicates the scanning of the first row of the raster scan, and [2] indicates the scanning of the second row of the raster scan.

FIG. 8B is a diagram showing control for shifting the range of the applied voltage width Vpp of the pixel voltage by applying a shift voltage (ΔV) of an even multiple (twice in this example) of a half-wave voltage (Vπ) to each of a plurality of Mach-Zehnder optical modulation units. FIG. 8B illustrates one of the plurality of Mach-Zehnder optical modulation units.

In FIG. 8B, [1] indicates the range of the applied voltage width Vpp in the first row scan [1] of the raster scan, which indicates the range of the applied voltage width Vpp before the shift voltage. Also, in FIG. 8B, [2] indicates the range of the applied voltage width Vpp in the second row scan [2] of the raster scan, which indicates the range of the applied voltage width Vpp after the shift voltage.

FIG. 8C shows the application patterns of pixel voltages over time for scanning [1] of the first column and scanning [2] of the second column shown in FIG. 8A.

In FIG. 8C, T₀ indicates the time during which the pixel voltage is continuously applied (pixel voltage application continuation period) in the scanning [1] of the first column and in the scanning [2] of the second column.

As shown in FIG. 8C, a positive pixel voltage was applied in the scan [1] of the first column, but by applying a shift voltage of 2Vπ to each of the multiple Mach-Zehnder optical modulation units at the timing when the scan [1] of the first column is completed (in other words, when the pixel voltage application continuation period T₀ has elapsed), a negative pixel voltage is applied in the scan [2] of the second column.

If the application of this shift voltage is referred to as a negative voltage shift, the control unit controls the application of the shift voltage at the timing when scanning of the second row is completed so as to perform a positive voltage shift, and controls the power supply so that negative voltage shifts and positive voltage shifts are repeated alternately.

In this way, by controlling so as to change the polarity of the voltage applied to the Mach-Zehnder optical modulation unit every predetermined pixel voltage application continuation period, it is possible to compensate for the DC drift.

The examples shown in FIGS. 8A to 8C are examples in which a shift voltage is applied at the timing when scanning of one row of raster scanning is completed, but the timing of application of the shift voltage may also be the timing when drawing of a group of pixels (pixel groups) of multiple rows of raster scanning is completed, or the timing when drawing of one or more frame images of raster scanning is completed.

The optical modulator of the present disclosure allows for DC drift compensation for each color, thereby allowing the same output light to be maintained.

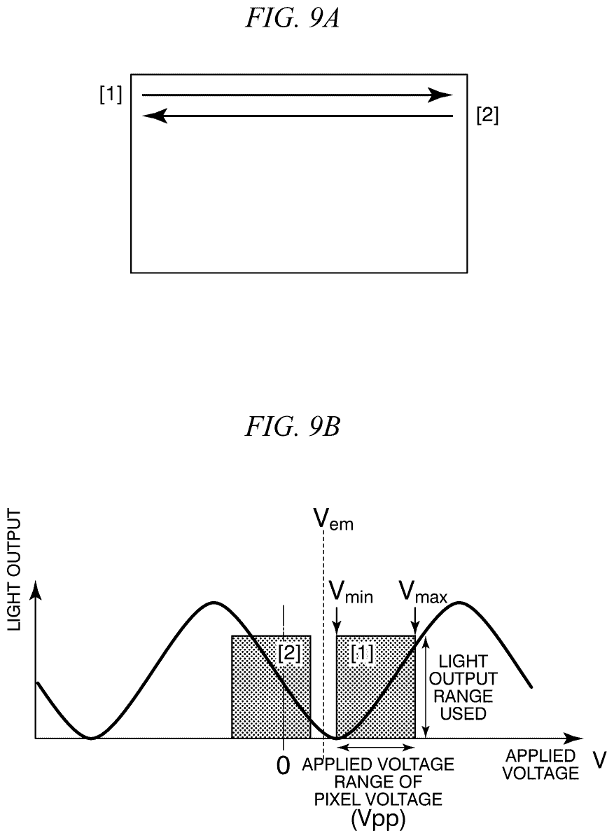

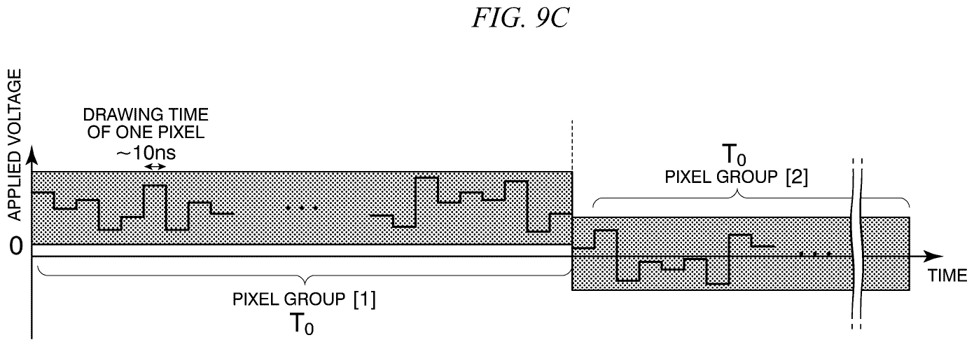

FIGS. 9A to 9C conceptually show a method of controlling pixel voltage application in an embodiment different from the embodiment shown in FIGS. 8A to 8C. FIGS. 9A to 9C correspond to FIGS. 8A to 8C, respectively. The example shown in FIGS. 9A to 9C is also a case where a shift voltage is applied for each row of raster scanning, similar to the example shown in FIGS. 8A to 8C.

FIG. 9A is a diagram corresponding to FIG. 8A, in which [1] shows the scanning of the first row of the raster scan, and [2] shows the scanning of the second row of the raster scan.

FIG. 9B shows a case where a shift voltage is applied so that the applied voltage range of the applied voltage width Vpp is shifted to a position symmetrical with respect to the minimum value (Vem) of the applied voltage in each modulation curve of a plurality of Mach-Zehnder type optical modulation sections. FIG. 9B shows a case where the symmetric axis passes through the minimum value, but the symmetric axis may pass through the maximum value. Before the shift voltage is applied, the optical output is maximum at the maximum voltage Vmax in the applied voltage range of the applied voltage width Vpp, and is minimum at the minimum voltage Vmin, but after the shift voltage is applied, the relationship between the maximum and minimum voltages of the optical output in the applied voltage range of the applied voltage width Vpp is reversed. Even in this embodiment, the effect of DC drift compensation is achieved as long as the shift voltage is controlled so that the applied voltage range after the shift voltage application includes a polarity opposite to that of the applied voltage before the shift voltage application.

The examples shown in FIGS. 9A to 9C are examples in which a shift voltage is applied at the timing when scanning of one row of raster scanning is completed, but the timing of application of the shift voltage may also be the timing when drawing of a group of pixels (pixel groups) of multiple rows of raster scanning is completed, or the timing when drawing of one or more frame images of raster scanning is completed.

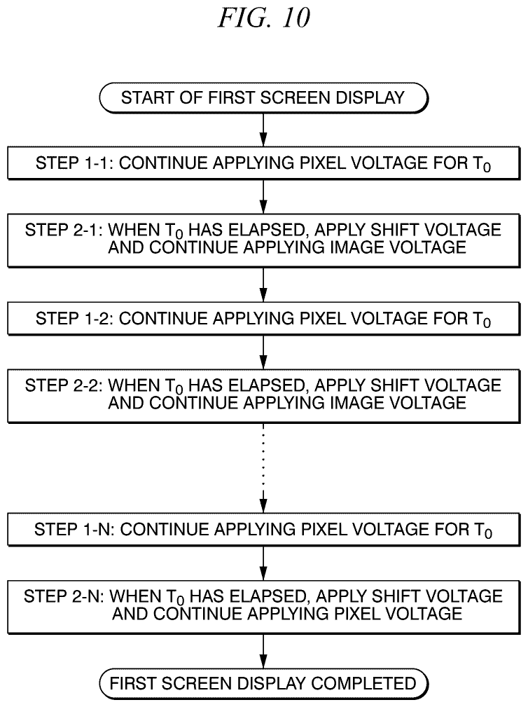

FIG. 10 is a flow chart showing an example of control executed by the control unit on the optical modulator during image formation. FIG. 10 shows control steps from the start of displaying the first screen to the completion of displaying the first screen. The embodiment shown in FIGS. 8A to 8C and the embodiment shown in FIGS. 9A to 9C are controlled by the same flow.

In step 1-1, in response to the scanning of the laser light, the Mach-Zehnder optical modulation unit of each color is controlled so as to apply a pixel voltage to each pixel for a predetermined pixel voltage application continuation period T₀.

In step 2-1, at the timing when T₀ has elapsed, a shift voltage is applied to the Mach-Zehnder optical modulation unit of each color, and control is performed so that a pixel voltage is applied to each pixel for the pixel voltage application continuation period T₀.

The flow thereafter is also a repetition of steps 1-1 and 2-1.

As described above, the control unit controls the sequential repeating of step 1 of continuing the application of the pixel voltage and step 2 of applying a shift voltage to the Mach-Zehnder optical modulator of each color at the timing when TO has elapsed and continuing the application of the pixel voltage until the formation of the first screen is completed.

After the formation of the first screen, the control unit controls the process to repeat steps 1 and 2 until the formation of the second screen is completed, and so on until the formation of the last screen is completed.

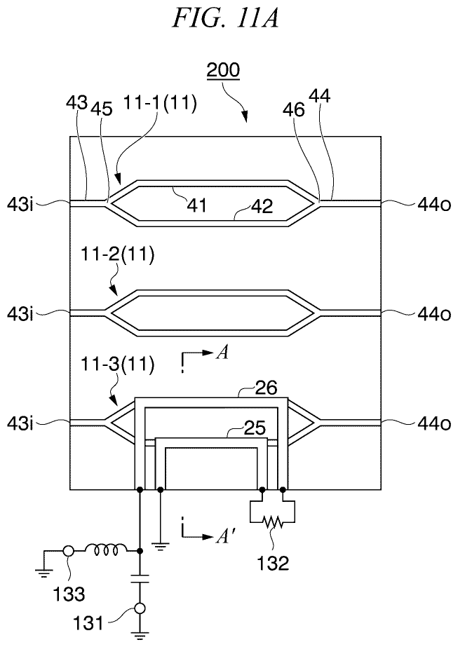

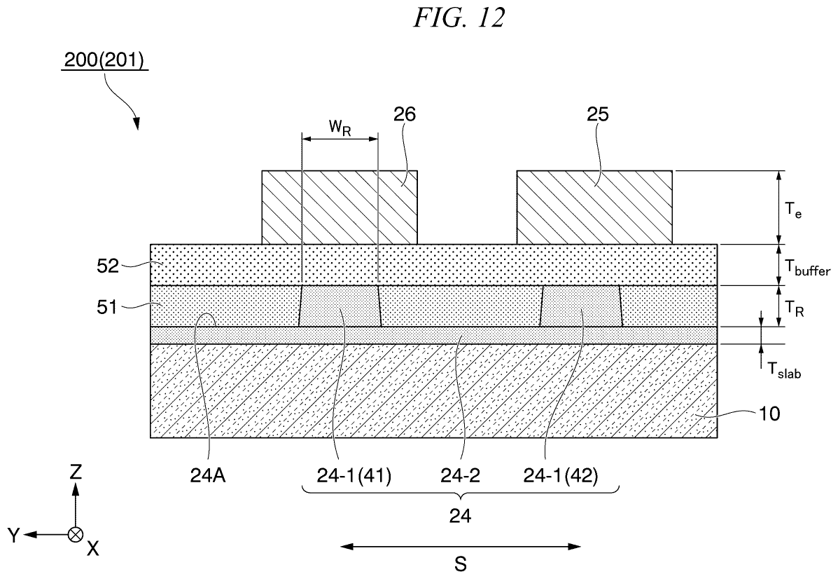

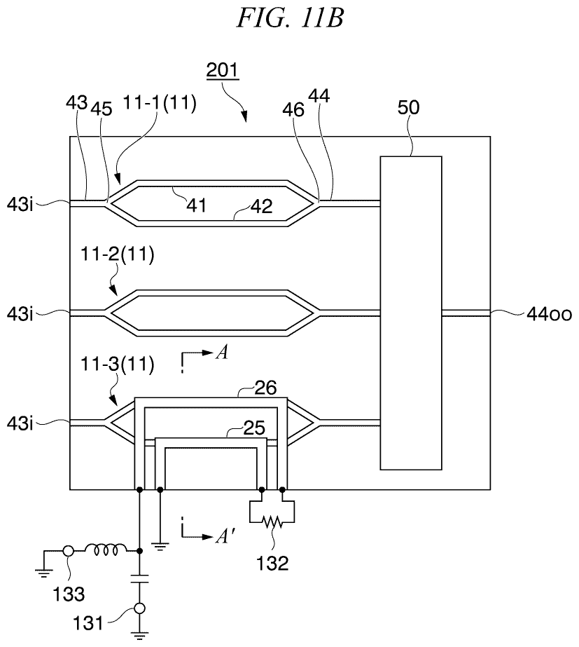

FIG. 11A is a schematic plan view of an optical modulator according to the present disclosure having three Mach-Zehnder optical waveguides 11 as shown in Figure The optical modulator 200 shown in FIG. 11A includes three Mach-Zehnder optical waveguides 11-1, 11-2, and 11-3, but three is just an example and the optical modulator 200 may include two or four or more.

In the optical modulator 200 shown in FIG. 11A, light inputted from each input port 43i of three Mach-Zehnder optical waveguides 11-1, 11-2, and 11-3 is outputted from an output port 440 of each optical waveguide.

The electrode configuration and the circuit diagram shown in FIG. 11A are an example. FIG. 11A shows a case where a DC bias voltage is superimposed on a high frequency signal applied to the electrodes 25 and 26.

The electrodes 25 and 26 are electrodes that apply a modulated voltage to each of the Mach-Zehnder optical waveguides 11-1, 11-2, and 11-3. The electrode 25 is an example of a first electrode, and the electrode 26 is an example of a second electrode. The power supply 131 is a part of a high-frequency signal pulse generation control circuit that applies a modulated voltage to each of the Mach-Zehnder optical waveguides 11. The power supply 133 is a part of a DC bias control circuit that applies a DC bias voltage to each of the Mach-Zehnder optical waveguides 11. For the sake of simplicity, the electrodes 25 and 26 are drawn only on the part of the Mach-Zehnder optical waveguide 11-3.

FIG. 11B is a schematic plan view of another example of an optical modulator according to the present disclosure, which is the same as the optical modulator shown in FIG. 11A except that it has an optical multiplexer.

In the optical modulator 201 shown in FIG. 11B, the light inputted from each of the input ports 43i of the three Mach-Zehnder optical waveguides 11-1, 11-2, and 11-3 is multiplexed in the optical multiplexing section 50 and outputted from one output port 4400.

FIG. 12 is a schematic cross-sectional view of the optical modulator shown in FIG. 11A taken along line AA′. The same is true for the schematic cross-sectional view of the optical modulator shown in FIG. 11B taken along line AA′.

The optical modulator 200 (201) shown in FIG. 12 has a substrate 10 made of a material different from lithium niobate, and a lithium niobate film 24 formed on the main surface of the substrate 10.

As shown in FIG. 12, the lithium niobate film 24 is composed of a ridge-type optical waveguide 24-1 (corresponding to the first ridge-type optical waveguide 41 and the second ridge-type optical waveguide 42) protruding from the first surface 24A, and a slab layer 24-2 which is the portion other than the ridge. However, the lithium niobate film 24 may be composed of only the ridge-type optical waveguide without having the slab layer.

When the optical modulator 200 (201) shown in FIG. 12 is used in an eyeglass-type image display device, the thickness (T_{slab}) of the slab layer 24-2 of the lithium niobate film 24 is preferably 0.1 to 0.3 μm, and the thickness (T_{R}) of the ridge-type optical waveguide 24-1 of the lithium niobate film 24 is preferably 0.5 to 1.0 μm. This is because if the thickness (T_{R}) of the ridge-type optical waveguide 24-1 is small, light will not propagate, and if it is large, the propagating light will be multi-mode.

When the optical modulator 200 (201) shown in FIG. 12 is used in an eyeglass-type image display device, the distance(S) between the ridge-type optical waveguides 24-1 is preferably 2 to 12 μm.

This is because by making S small, the efficiency of the electric field applied to the ridge-type optical waveguide 24-1 can be increased.

Furthermore, the width (W_{R}) of the top surface of the ridge-type optical waveguide 24-1 is preferably 0.3 to 1.2 μm.

This is because if the waveguide width is small, light will not propagate, and if it is large, the propagating light will be multi-mode.

Examples of the substrate 10 include a sapphire substrate, a Si substrate, and a thermally oxidized silicon substrate.

Since the optical multiplexing functional layer 20 is made of a lithium niobate (LiNbO₃) film, there are no particular limitations on the substrate as long as it has a lower refractive index than the lithium niobate film, but a sapphire single crystal substrate or a silicon single crystal substrate is preferred as a substrate on which a single crystal lithium niobate film can be formed as an epitaxial film. The crystal orientation of the single crystal substrate is not particularly limited, but since, for example, a c-axis oriented lithium niobate film has three-fold symmetry, it is desirable for the underlying single crystal substrate to have the same symmetry, and in the case of a sapphire single crystal substrate, a c-plane substrate is preferred, and in the case of a silicon single crystal substrate, a (111) plane substrate is preferred.

The lithium niobate film is, for example, a c-axis oriented lithium niobate film. The lithium niobate film is, for example, an epitaxial film epitaxially grown on the substrate 10. The epitaxial film is a single crystal film whose crystal orientation is aligned by the underlying substrate. The epitaxial film is a film having a single crystal orientation in the z direction and the xy in-plane direction, and the crystals are aligned in the x-axis, y-axis, and z-axis directions. Whether the film formed on the substrate 10 is an epitaxial film can be proved by, for example, checking the peak intensity and pole at the orientation position in 2θ-θ X-ray diffraction.

Specifically, when measured by 2θ-θ X-ray diffraction, all peak intensities other than the target plane are 10% or less, preferably 5% or less, of the maximum peak intensity of the target plane. For example, when the lithium niobate film is a c-axis oriented epitaxial film, the peak intensities other than the (00L) plane are 10% or less, preferably 5% or less, of the maximum peak intensity of the (00L) plane. Here, (00L) is a general designation for equivalent planes such as (001) and (002).

Moreover, the conditions for confirming the peak intensity at the orientation position described above only indicate the orientation in one direction. Therefore, even if the above conditions are obtained, if the crystal orientation is not aligned in the plane, the intensity of the X-rays will not increase at a specific angle position, and no poles will be observed. For example, when the lithium niobate film is a lithium niobate film, since LiNbO₃ has a trigonal crystal structure, there are three poles of LiNbO₃ (014) in the single crystal. In the case of lithium niobate, it is known that the epitaxial growth occurs in a so-called twin state in which crystals rotated 180° around the c-axis are symmetrically bonded. In this case, the three poles are symmetrically bonded to two, so there are six poles. In addition, when a lithium niobate film is formed on a silicon single crystal substrate with a (100) plane, the substrate is four-fold symmetric, so 4×3=12 poles are observed. In this disclosure, a lithium niobate film epitaxially grown in a twin state is also included in the epitaxial film.

The composition of lithium niobate is LiₓNbA_{y}O_{z}. A is an element other than Li, Nb, and O. x is 0.5 or more and 1.2 or less, and preferably 0.9 or more and 1.05 or less. y is 0 or more and 0.5 or less. z is 1.5 or more and 4.0 or less, and preferably 2.5 or more and 3.5 or less. The element A is, for example, K, Na, Rb, Cs, Be, Mg, Ca, Sr, Ba, Ti, Zr, Hf, V, Cr, Mo, W, Fe, Co, Ni, Zn, Sc, and Ce, and two or more of these elements may be combined.

Furthermore, the lithium niobate film may be a lithium niobate single crystal thin film bonded onto a substrate.

### (Protective Layer 51)

As shown in FIG. 2, the protective layer 51 is disposed between the slab layer 24-2 of the lithium niobate film 24 and the buffer layer 52. The protective layer 51 is made of a dielectric material with a smaller refractive index than the lithium niobate film 24. Examples of the material that can be used for the protective layer 51 include silicon oxide (SiO₂), aluminum oxide (Al₂O₃), lanthanum oxide (La₂O₃), and compounds of these oxides. Examples of the compounds of the oxides include LaAlSiInO. Of the above, it is preferable to use silicon oxide (SiO₂) as the material for the protective layer 51.

### (Buffer Layer 52)

The buffer layer 52 is formed on the lithium niobate film 24 and the protective layer 51, and prevents visible light propagating through the lithium niobate film 24 from being absorbed by the electrode layer.

The buffer layer 52 is made of a dielectric material having a smaller refractive index than the lithium niobate film 24. The dielectric material constituting the buffer layer 52 preferably has a dielectric constant of 7 or more, because this can reduce the electric field efficiency VIL.

Specific examples of the material of the buffer layer 52 include aluminum oxide (Al₂O₃, dielectric constant 7) and LaAlSiInO (dielectric constant 11).

The material of the buffer layer 52 may be the same as that of the protective layer 51 or may be a different material.

The thickness (T_{buffer}) of the buffer layer 52 is preferably 0.4 μm or more and 1 μm or less. This is because the electric field efficiency VπL can be reduced.

### (Electrodes 25, 26)

When the optical modulator of the present disclosure is used in an eyeglass-type image display device, the width (We) of the electrodes 25, 26 is preferably 1.0 to 4.0 μm.

This is because the electric field efficiency VIL can be reduced.

When the optical modulator of the present disclosure is used in an eyeglass-type image display device, the thickness (Te) of the electrodes 25, 26 is preferably 0.1 to 5 μm.

This is because when the modulation frequency is high, the microwave propagates more efficiently when the electrode cross-sectional area is large.

A ridge-type optical waveguide is formed by a bulk lithium niobate layer attached to a substrate;

The C-axis of the lithium niobate may be parallel to the main surface of the substrate.

### [Light Source Module]

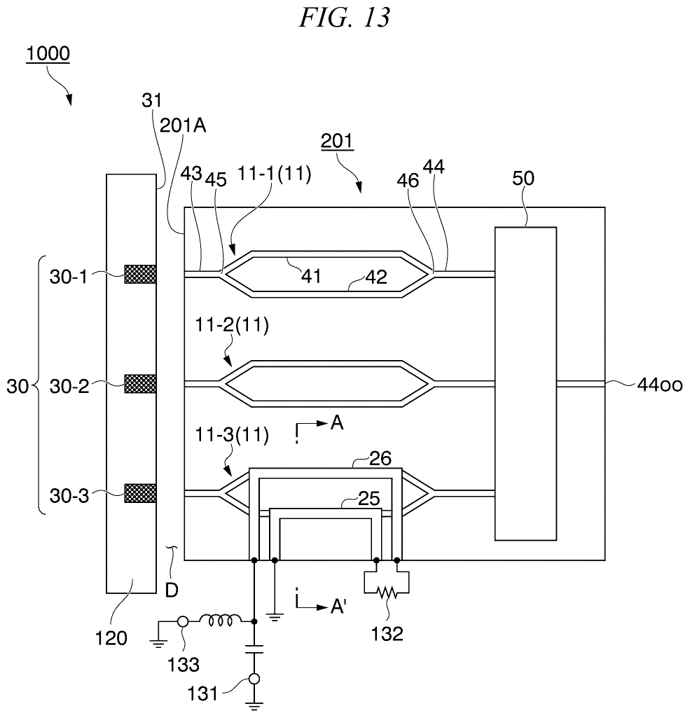

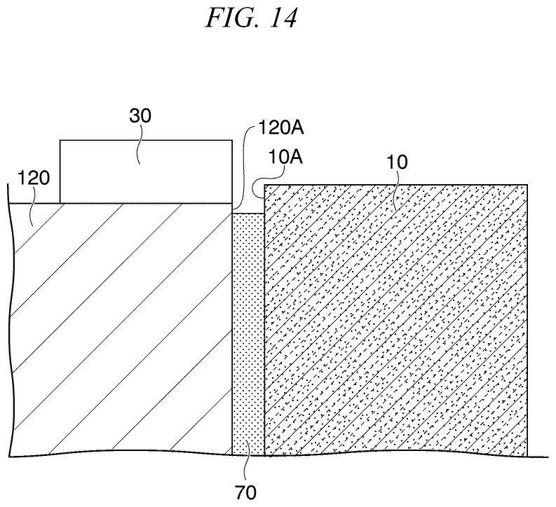

A light source module according to the present disclosure includes an optical modulator according to the present disclosure and a plurality of laser light sources. FIG. 13 is a schematic plan view of a light source module according to the present disclosure. FIG. 13 shows an example of a light source module including the optical modulator 201 shown in FIG. 12. FIG. 14 is a schematic cross-sectional view of a part of the light source module shown in FIG. 13 cut along the XZ plane, depicting only a part near the joint.

The light source module 1000 shown in FIG. 13 includes an optical modulator 201 and three laser light sources 30 (30-1, 30-2, 30-3) that emit light to be modulated by the optical modulator 201.

Various laser elements can be used as the laser light source 30. The laser light source 30 can emit visible light. In this case, the light source module 1000 is a visible light source module.

The three laser light sources 30-1, 30-2, and 30-3 may be, for example, commercially available laser diodes (LDs) that emit red, green, and blue light. The red light may have a peak wavelength of 610 nm or more and 750 nm or less, the green light may have a peak wavelength of 500 nm or more and 560 nm or less, and the blue light may have a peak wavelength of 435 nm or more and 480 nm or less.

In the light source module 1000, the laser light sources 30-1, 30-2, and 30-3 are respectively an LD that emits green light, an LD that emits blue light, and an LD that emits red light. The LDs 30-1, 30-2, and 30-3 are disposed at intervals in a direction substantially perpendicular to the emission direction of the light emitted from each LD, and are provided on the upper surface of the subcarrier 120.

The LD 30 can be mounted as a bare chip on the subcarrier 120. The subcarrier 120 is made of, for example, aluminum nitride (AlN), aluminum oxide (Al₂O₃), silicon (Si), or the like.

The subcarrier 120 can be directly bonded to the substrate 10 via a metal bonding layer. This configuration makes it possible to further reduce the size by eliminating spatial coupling or fiber coupling.

By configuring the subcarrier 120 and the substrate 10 to be joined via a metal bonding layer, the relative positions of the subcarrier 120 and the substrate 10 can be adjusted during manufacture to align the optical axis position of the laser light so that the optical axis of each visible light laser coincides with the axis of each optical waveguide 43 (active alignment).

In the light source module 1000, the light exit surface 31 of the LD 30 and the light entrance surface (side surface) 201A of the optical modulator 201 are arranged at a predetermined interval. The light entrance surface 201A faces the light exit surface 31, and there is a gap D between the light exit surface 31 and the light entrance surface 201A in the x direction. Since the light source module 1000 is exposed to the air, the gap D is filled with air. Since the gap D is filled with the same gas (air), it is easy to make each color light emitted from the LD 30 enter the entrance path while satisfying a predetermined coupling efficiency. When the light source module 1000 is used for AR glasses and VR glasses, the size of the gap (spacing) D in the x direction is, for example, greater than 0 μm and less than 5 μm, taking into account the amount of light required for the AR glasses and VR glasses.

### [Optical Engine and XR Glasses]

In this specification, an optical engine refers to a device that includes a plurality of light sources, an optical system including a multiplexing section that combines a plurality of light beams emitted from the plurality of light sources into a single beam of light, an optical scanning mirror configure to reflect the light emitted from the optical system at a different angle so as to display an image, and a control element that controls the optical scanning mirror.

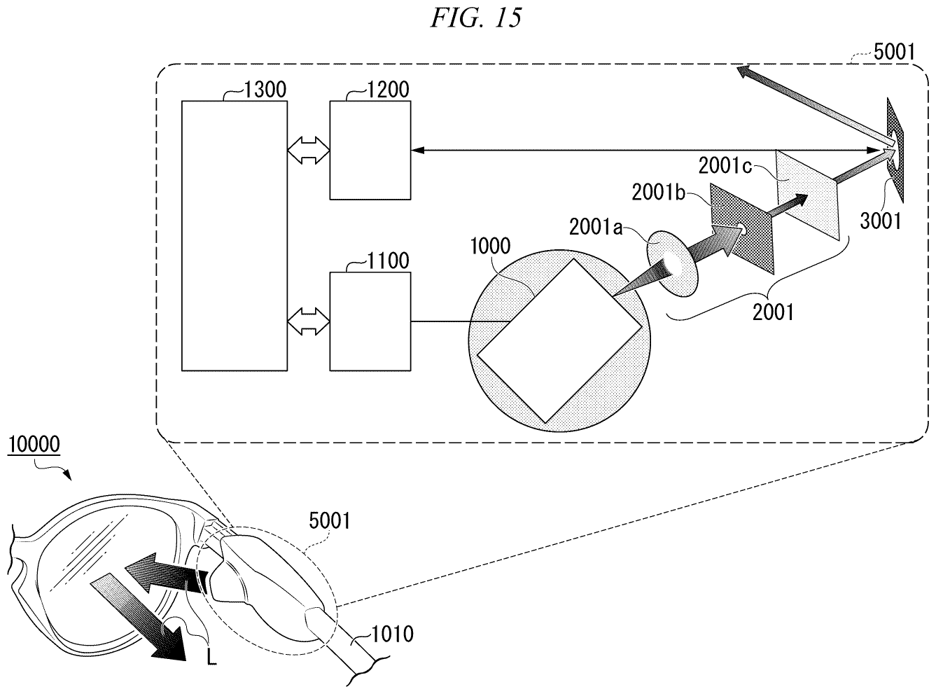

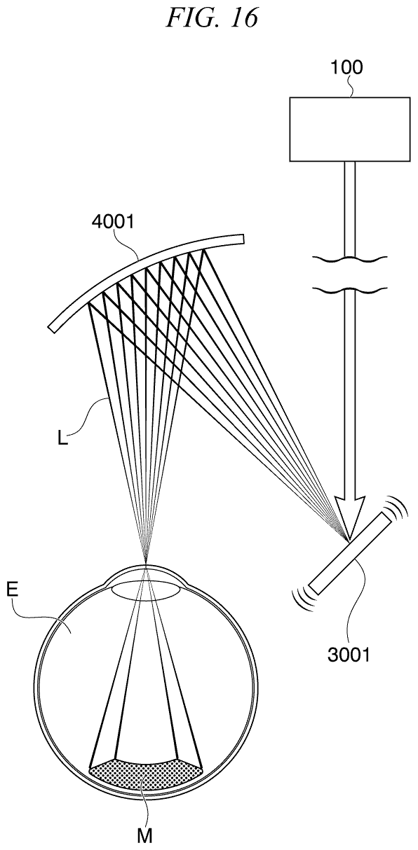

FIG. 15 is a conceptual diagram for explaining an example of the XR glasses of the present disclosure. FIG. 16 is a conceptual diagram showing a state in which an image is directly projected onto a retina by a laser light emitted from a light source module in the XR glasses shown in FIG. 15. The symbol L is an image display light.

The XR glasses (eyeglasses) 10000 of the present disclosure are glasses-type terminals. XR is a general term for virtual reality (VR), augmented reality (AR), and mixed reality. The symbol L shown in FIG. 16 denotes image display light.

The XR glasses 10000 of the present disclosure shown in FIG. 15 are configured such that the light source module 1000 according to the above-described embodiment is mounted on an optical engine 5001 disposed on a frame 1010. As shown in FIG. 15, the optical engine 5001 has a light source module 1000, an optical scanning mirror 3001, an optical system 2001 connecting the light source module 1000 and the optical scanning mirror 3001, a laser driver 1100, an optical scanning mirror driver 1200, and a video controller 1300 that controls these drivers.

For example, a MEMS mirror can be used as the optical scanning mirror 3001. In order to project a 2D image, it is preferable to use, as the optical scanning mirror 3001, a two-axis MEMS mirror that vibrates so as to reflect laser light by changing angles in the horizontal direction (X direction) and the vertical direction (Y direction).

The optical system 2001 optically processes the laser light emitted from the light source module 1000. As the optical system 2001, for example, one having a collimator lens 2001a, a slit 2001b, and an ND filter 2001c can be used. The optical system 2001 shown in FIG. 15 is an example, and other configurations may be used.

In the XR glasses 10000 of the present disclosure shown in FIG. 15, as shown in FIG. 16, the laser light R irradiated from the light source module 1000 attached to the frame 1010 is reflected by the light scanning mirror 3001, and further reflected by the lens 4001 of the XR glasses 10000, and enters the person's eyeball E as image display light L, so that an image (video) can be directly projected onto the retina M.

The XR glasses 10000 of the present disclosure are equipped with the light source module 1000 of the present disclosure, and therefore have reduced electric field efficiency.

### REFERENCE SYMBOL

1 Mach-Zehnder optical modulator
2 Control Unit
10 Substrate
100, 200, 201 Optical modulator
1000 Light source module
5001 Optical Engine
10000 XR Glasses

1. An optical modulator for an image display device that displays an image on an image display surface by scanning a combined light of a plurality of color laser beams pixel by pixel at a predetermined time step, the optical modulator comprising:
a plurality of Mach-Zehnder optical modulation units, each of which has a Mach-Zehnder optical waveguide formed of a ridge formed in a ferroelectric thin film represented by the chemical formula ABX₃ and an electrode for applying an electric field to the Mach-Zehnder optical waveguide;
a power supply for applying a pixel voltage to each of the plurality of Mach-Zehnder optical modulation units independently; and
a control unit configured to control the power supply, wherein
the control unit is configured to control the power supply so as to apply the pixel voltage with a predetermined applied voltage width to each of the plurality of Mach-Zehnder optical modulation units independently,
the control unit further configured to repeat a set of a step 1 and a step 2, in the step 1, application of the pixel voltage having one polarity to each of the plurality of Mach-Zehnder optical modulation units being continued during a predetermined pixel voltage application continuation period, and in the step 2, a shift voltage that is an even multiple of a half-wavelength voltage being applied to each of the plurality of Mach-Zehnder optical modulation units and application of the pixel voltage having other polarity being continued during the pixel voltage application continuation period after performing the step 1 in the set.

2. An optical modulator for an image display device that displays an image on an image display surface by scanning a combined light of a plurality of color laser beams pixel by pixel at a predetermined time step, the optical modulator comprising:
a plurality of Mach-Zehnder optical modulation units, each of which has a Mach-Zehnder optical waveguide formed of a ridge formed in a ferroelectric thin film represented by the chemical formula ABX₃ and an electrode for applying an electric field to the Mach-Zehnder optical waveguide;
a power supply for applying a pixel voltage to each of the plurality of Mach-Zehnder optical modulation units independently; and
a control unit configured to control the power supply, wherein
the control unit is configured to control the power supply so as to apply the pixel voltage with a predetermined applied voltage width to each of the plurality of Mach-Zehnder optical modulation units independently,
the control unit further configured to repeat a set of a step 1 and a step 2, in the step 1, application of the pixel voltage having one polarity to each of the plurality of Mach-Zehnder optical modulation units being continued during a predetermined pixel voltage application continuation period, and in the step 2, a shift voltage being applied to each of the plurality of Mach-Zehnder optical modulation units so that the applied voltage width is symmetrical with respect to an extreme value of an optical output in each modulation curve of the plurality of Mach-Zehnder type optical modulation units and application of a pixel voltage including the pixel voltage having other polarity being continued during the pixel voltage application continuation period after performing the step 1 in the set.

3. The optical modulator according to claim 1, wherein the Mach-Zehnder optical waveguide is made of C-axis oriented lithium niobate.

4. The optical modulator according to claim 2, wherein the Mach-Zehnder optical waveguide is made of C-axis oriented lithium niobate.

5. The optical modulator according to claim 1, wherein the Mach-Zehnder optical waveguide is made of X-cut lithium niobate.

6. The optical modulator according to claim 2, wherein the Mach-Zehnder optical waveguide is made of X-cut lithium niobate.

7. The optical modulator according to claim 1, wherein the pixel voltage application continuation period is a time required to draw one or more rows of pixels in a raster scan.

8. The optical modulator of claim 2, wherein the pixel voltage application continuation period is a time required to draw one or more rows of pixels in a raster scan.

9. The optical modulator according to claim 1, wherein the pixel voltage application continuation period is a time required to draw one or more frame images in a raster scan.

10. The optical modulator according to claim 2, wherein the pixel voltage application continuation period is a time required to draw one or more frame images in a raster scan.

11. A visible light source module comprising:
the optical modulator according to claim 1; and
a plurality of visible light laser light sources each emitting a plurality of colored laser beams.

12. An optical engine comprising:
the visible light source module according to claim 11; and
an optical scanning mirror configure to reflect the light emitted from the visible light source module at a different angle so as to display an image.

13. An image display device comprising the optical engine according to claim 12.

14. The image display device according to claim 13, wherein the image display device is an XR glass.

15. A method for controlling an optical modulator for an image display device that displays an image on an image display surface by scanning a combined light of a plurality of colored laser beams pixel by pixel at a predetermined time step, the method comprising the steps of:
using an optical modulator including a plurality of Mach-Zehnder optical modulation units, a power supply for applying a pixel voltage to each of the plurality of Mach-Zehnder optical modulation units independently, and a control unit configured to control the power supply; and
by the controlling unit, controlling the power supply so as to apply the pixel voltage with a predetermined applied voltage width to each of the plurality of Mach-Zehnder optical modulation units independently, and further controlling such that a set of a step 1 and a step 2 is repeated, in the step 1, application of the pixel voltage having one polarity to each of the plurality of Mach-Zehnder optical modulation units being continued during a predetermined pixel voltage application continuation period, and in the step 2, a shift voltage that is an even multiple of a half-wavelength voltage being applied to each of the plurality of Mach-Zehnder optical modulation units and application of the pixel voltage having other polarity being continued during the pixel voltage application continuation period after performing the step 1 in the set.

16. A method for controlling an optical modulator for an image display device that displays an image on an image display surface by scanning a combined light of a plurality of colored laser beams pixel by pixel at a predetermined time step, the method comprising the steps of:
using an optical modulator including a plurality of Mach-Zehnder optical modulation units, a power supply for applying a pixel voltage to each of the plurality of Mach-Zehnder optical modulation units independently, and a control unit configured to control the power supply; and
by the controlling unit, controlling the power supply so as to apply the pixel voltage with a predetermined applied voltage width to each of the plurality of Mach-Zehnder optical modulation units independently, and further controlling such that a set of a step 1 and a step 2 is repeated, in the step 1, application of the pixel voltage having one polarity to each of the plurality of Mach-Zehnder optical modulation units being continued during a predetermined pixel voltage application continuation period, and in the step 2, a shift voltage being applied to each of the plurality of Mach-Zehnder optical modulation units so that the applied voltage width is symmetrical with respect to an extreme value of an optical output in each modulation curve of the plurality of Mach-Zehnder type optical modulation units and application of a pixel voltage including the pixel voltage having other polarity being continued during the pixel voltage application continuation period after performing the step 1 in the set.
